(19) United States
(12) Patent Application Publication
(10) Pub. No.: US 2025/0035426 A1
(43) Pub. Date: Jan. 30, 2025

(54) THREE-DIMENSIONAL SHAPE MEASURING DEVICE AND THREE-DIMENSIONAL SHAPE MEASURING METHOD

(71) Applicant: Tokyo Seimitsu Co., Ltd., Tokyo (JP)

(72) Inventors: Takashi OGURA, Tsuchiura-city (JP); Xiaonan WANG, Tsuchiura-city (JP)

(73) Assignee: Tokyo Seimitsu Co., Ltd., Tokyo (JP)

(21) Appl. No.: 18/891,105

(22) Filed: Sep. 20, 2024

Related U.S. Application Data
(63) Continuation of application No. PCT/JP2023/008762, filed on Mar. 8, 2023.

(30) Foreign Application Priority Data
Mar. 22, 2022 (JP) 2022-045707

(51) Int. Cl. G01B 9/0209; G01B 9/04; G01B 11/24

(52) U.S. Cl. CPC G01B 9/0209; G01B 9/04; G01B 11/2441

(57) ABSTRACT

A three-dimensional shape measuring device includes: an interference objective lens including an interfering unit configured to separate part of measurement light as reference light and generate multiplexed light of the measurement light returning from the surface to be measured and the reference light returning from a reference surface, and an objective lens configured to cause the measurement light to focus on the surface to be measured; a scanning unit configured to cause the interference objective lens to scan relatively with respect to the surface to be measured; an image capturing unit configured to repeatedly capture an image of the multiplexed light and output a plurality of captured images during scanning; and a first signal processing unit configured to calculate the three-dimensional shape of the surface to be measured, based on a result of comparing the sharpness of each pixel on the same coordinate of the plurality of captured images.

### CROSS-REFERENCE TO RELATED APPLICATIONS

The present application is a Continuation of PCT International Application No. PCT/JP2023/008762 filed on Mar. 8, 2023 claiming priority under 35 U.S.C § 119(a) to Japanese Patent Application No. 2022-045707 filed on Mar. 22, 2022. Each of the above applications is hereby expressly incorporated by reference, in their entirety, into the present application.

### BACKGROUND OF THE INVENTION

### Field of the Invention

The presently disclosed subject matter relates to a three-dimensional shape measuring device and a three-dimensional shape measuring method that measure a three-dimensional shape of a surface to be measured by a focal point method.

### Description of the Related Art

There is known a three-dimensional shape measuring device that optically measures three-dimensional shapes, such as all-in-focus images, surface shapes, and surface roughness shapes of a surface to be measured of a measurement object by a focal point method (focus variation (FV) scheme) (see PTL 1 and PTL 2).

The three-dimensional shape measuring device employing the FV scheme includes a drive mechanism, a microscope equipped with a camera, and a control device. The drive mechanism causes the microscope to scan in a scanning direction (height direction). While the microscope is being caused to scan by the drive mechanism, the camera continuously captures images of a surface to be measured to acquire a plurality of captured images. The control device measures the three-dimensional shape of the surface to be measured based on a result of calculating sharpness of each captured image and comparing the sharpness of each pixel on the same coordinate of each captured image.

The three-dimensional shape measurement using the FV scheme has advantages of being suitable for three-dimensional shape measurement of inclined surfaces and enabling high-speed measurement as compared with the three-dimensional shape measurement employing a white light interference scheme (white light interferometry: WLI). On the other hand, the three-dimensional shape measurement employing the FV scheme has disadvantages of having lower resolution in the height direction of a surface to be measured and also being unable to measure a surface to be measured, such as a mirror surface, that has less change in luminance, as compared with the three-dimensional shape measurement employing the WLI scheme.

PTL 1 discloses a surface shape detecting device used in a case of performing three-dimensional shape measurement of a mirror-like surface to be measured by the FV scheme, in which patterns, such as texture patterns, are projected on the surface to be measured. The surface shape detecting device improves the contrast of the surface to be measured by projecting the texture patterns on the surface to be measured, and thereby improves measurement accuracy of the three-dimensional shape of the surface to be measured.

PTL 2 discloses a shape measuring device including optical means, a scanning stage, interference light generation means, an image capturing unit, and a light shielding plate. The optical means, which has a depth of field equal to or less than the measurement accuracy of a three-dimensional shape of a surface to be measured, guides measurement light downward to the surface to be measured, and also guides reflective light upward. The scanning stage scans the surface to be measured in a scanning direction (height direction). The interference light generation means generates reference light that interferes with the reflective light. The image capturing unit captures an image of “reflective light” or “interference light between the reflective light and the reference light”. The light shielding plate is insertably and removably provided in a light path of the reference light to switch between capturing of an image of the reflective light and capturing of an image of the interference light by an image capturing unit. In the shape measuring device in PTL 2, when the three-dimensional shape of an inclined surface to be measured is measured by the FV scheme, the image capturing unit captures an image of interference light. As a result, the contrast of a taken image is improved by interference fringes included in the captured image captured by the image capturing unit, so that the measurement accuracy of the three-dimensional shape of the surface to be measured is improved.

### CITATION LIST

### Patent Literature

PTL 1: Japanese Patent Application Laid-Open No. 6-201337
PTL 2: Japanese Patent Application Laid-Open No. 10-68616

### SUMMARY OF THE INVENTION

Incidentally, in the surface shape detecting device described in PTL 1, it is necessary to provide a projection system in the microscope to project texture patterns on the surface to be measured, though it may not be possible to provide the projection system depending on the type (structure) of the microscope. Therefore, the method described in PTL 1 is unable to easily improve the measurement accuracy of the three-dimensional shape of the surface to be measured.

In the shape measuring device described in PTL 2, it is necessary to provide the interference light generation means and the light shielding plate in the microscope, though it may not be possible to provide the interference light generation means and the light shielding plate depending on the type (structure) of the microscope. Therefore, the method described in PTL 2 is also unable to easily improve the measurement accuracy of the three-dimensional shape of the surface to be measured. Another problem with the shape measuring device described in PTL 2 is that an examiner is required to insert and remove the light shielding plate, which is laborious. In addition, in the shape measuring device described in PTL 2, it is necessary to provide the optical means having the depth of field that is equal to or less than the measurement accuracy of the three-dimensional shape of the surface to be measured.

An object of the presently disclosed subject matter, which has been made in view of such circumstances, is to provide a three-dimensional shape measuring device and a three-dimensional shape measuring method capable of reducing the time and effort of an examiner and easily improving the measurement accuracy of the three-dimensional shape of a surface to be measured.

In order to accomplish the object of the presently disclosed subject matter, a three-dimensional shape measuring device configured to measure a three-dimensional shape of a surface to be measured by a focal point method includes: a light source unit configured to emit measurement light; an interference objective lens including an interfering unit configured to separate part of the measurement light emitted from the light source unit as reference light, emit the measurement light to the surface to be measured, emit the reference light to a reference surface, and generate multiplexed light of the measurement light returning from the surface to be measured and the reference light returning from the reference surface, and an objective lens configured to cause the measurement light to focus on the surface to be measured; a scanning unit configured to cause the interference objective lens to scan in a scanning direction that is parallel to an optical axis of the objective lens relatively with respect to the surface to be measured; an image capturing unit configured to repeatedly capture an image of the multiplexed light generated by the interfering unit and output a plurality of captured images including interference fringes during scanning by the scanning unit; and a first signal processing unit configured to calculate sharpness of each pixel of the plurality of captured images output from the image capturing unit and calculate the three-dimensional shape of the surface to be measured, based on a result of comparing the sharpness of each pixel on the same coordinate of the plurality of captured images.

Since the three-dimensional shape measuring device is easily applicable to existing devices, it is possible to easily improve the measurement accuracy of the three-dimensional shape of a surface to be measured W and to further reduce the time and effort required for the examiner to insert and remove the light shielding plate.

In the three-dimensional shape measuring device according to another aspect of the presently disclosed subject matter, when an optical path length of the measurement light between the interfering unit and the surface to be measured is set as a measurement light path length and an optical path length of the reference light between the interfering unit and the reference surface is set as a reference light path length, the measurement light path length is equal to the reference light path length. By this means, the intensity of the interference fringes in the captured image can be increased, and the contrast of the surface to be measured in the captured image can be further improved.

The three-dimensional shape measuring device according to still another aspect of the presently disclosed subject matter includes: a second signal processing unit configured to calculate height information of the surface to be measured for each pixel to calculate the three-dimensional shape of the surface to be measured based on luminance values for each pixel on the same coordinate of the plurality of captured images output from the image capturing unit; a first evaluation value calculating unit configured to calculate an evaluation value of a calculation result of the first signal processing unit and an evaluation value of a calculation result of the second signal processing unit; and a determining unit configured to determine a calculation result of the three-dimensional shape of the surface to be measured out of the calculation result of the first signal processing unit or the calculation result of the second signal processing unit, whichever has a higher evaluation value based on results of calculation of the first evaluation value calculating unit. By this means, measurement by the FV scheme and the WLI scheme can be executed in one measurement operation (scanning).

The three-dimensional shape measuring device according to yet another aspect of the presently disclosed subject matter includes: a second signal processing unit configured to calculate height information of the surface to be measured for each pixel to calculate the three-dimensional shape of the surface to be measured based on luminance values for each pixel on the same coordinate of the plurality of captured images output from the image capturing unit; a second evaluation value calculating unit configured to calculate for each pixel an evaluation value of a calculation result of the first signal processing unit and an evaluation value of a calculation result of the second signal processing unit; and an integrating unit configured to generate an integrated three-dimensional shape of the surface to be measured by selecting, for each pixel, the calculation result of the first signal processing unit or the calculation result of the second signal processing unit, whichever has a higher evaluation value based on results of calculation of the second evaluation value calculating unit. This makes it possible to obtain both the advantage of the measurement by the FV scheme and the advantage of the measurement by the WLI scheme.

In the three-dimensional shape measuring device according to another aspect of the presently disclosed subject matter, the evaluation value is a signal to noise ratio.

In the three-dimensional shape measuring device according to still another aspect of the presently disclosed subject matter, the scanning unit causes a microscope including the interference objective lens and the image capturing unit to scan relatively with respect to the surface to be measured.

In order to accomplish the object of the presently disclosed subject matter, a three-dimensional shape measuring method that measures a three-dimensional shape of a surface to be measured by a focal point method includes: an emitting step of emitting measurement light; an interfering step of separating part of the measurement light emitted in the emitting step as reference light, emitting the measurement light to the surface to be measured, emitting the reference light to a reference surface, and generating multiplexed light of the measurement light returning from the surface to be measured and the reference light returning from the reference surface; a scanning step of causing an interference objective lens, including an interfering unit that performs the interfering step and an objective lens that causes the measurement light to focus on the surface to be measured, to scan in a scanning direction that is parallel to an optical axis of the objective lens relatively with respect to the surface to be measured; an image capturing step of repeatedly capturing an image of the multiplexed light generated in the interfering step and outputting a plurality of captured images including interference fringes during the scanning step; and a signal processing step of calculating sharpness of each pixel of the plurality of captured images output in the image capturing step and calculating the three-dimensional shape of the surface to be measured, based on a result of comparing the sharpness of each pixel on the same coordinate of the plurality of captured images.

The presently disclosed subject matter can reduce the time and effort of an examiner and easily improve the measurement accuracy of the three-dimensional shape of a surface to be measured.

### BRIEF DESCRIPTION OF THE DRAWINGS

FIG. 1 is a schematic view of a three-dimensional shape measuring device of a first embodiment;

FIG. 2 indicates an example of a captured image of a surface to be measured captured by a camera;

FIG. 3 is a functional block diagram of a control device of the first embodiment;

FIG. 4 is an explanatory diagram for describing calculation of a three-dimensional shape of the surface to be measured by a signal processing unit;

FIG. 5 is a flowchart indicating flow of processing of measuring the three-dimensional shape of the surface to be measured by the three-dimensional shape measuring device of the first embodiment;

A reference numeral 6A of FIG. 6 is a front view of a captured image obtained in a comparative example using an observational lens in measurement by a FV scheme, and a reference numeral 6B of FIG. 6 is an enlarged view of a given sharpness calculation range in the captured image;

A reference numeral 7A of FIG. 7 is a front view of a captured image obtained in a present example using an interference objective lens in the measurement by the FV scheme, and a reference numeral 7B of FIG. 7 is an enlarged view of a given sharpness calculation range in the captured image;

FIG. 8 is an explanatory diagram indicating an example of an optical flat surface shape, which is the three-dimensional shape of an optical flat surface measured in the comparative example;

FIG. 9 is an explanatory diagram indicating an example of an optical flat surface shape, which is the three-dimensional shape of an optical flat surface measured in the present example;

FIG. 10 is a graph indicating comparison between a cross-sectional curve of the optical flat surface based on the optical flat surface shape in the comparative example and a cross-sectional curve of the optical flat surface based on the optical flat surface shape in the present example;

FIG. 11 is an explanatory diagram indicating an example of a ball bearing surface shape, which is the three-dimensional shape of a ball bearing surface measured in the comparative example;

FIG. 12 is an explanatory diagram indicating an example of a ball bearing surface shape, which is the three-dimensional shape of a ball bearing surface measured in the present example;

FIG. 13 is a graph indicating comparison between a cross-sectional curve of the ball bearing surface based on the ball bearing surface shape in the comparative example and a cross-sectional curve of the ball bearing surface based on the ball bearing surface shape in the present example;

FIG. 14 is a graph indicating a cross-sectional curve of an optical flat surface measured in the first embodiment;

FIG. 15 is a functional block diagram of a control device for a three-dimensional shape measuring device of a second embodiment;

FIG. 16 is a flowchart indicating flow of processing of measuring the three-dimensional shape of a surface to be measured by the three-dimensional shape measuring device of the second embodiment;

FIG. 17 is a functional block diagram of a control device for a three-dimensional shape measuring device of a third embodiment; and

FIG. 18 is a flowchart indicating flow of processing of measuring the three-dimensional shape of a surface to be measured by the three-dimensional shape measuring device of the third embodiment.

### DESCRIPTION OF THE EMBODIMENTS

### First Embodiment

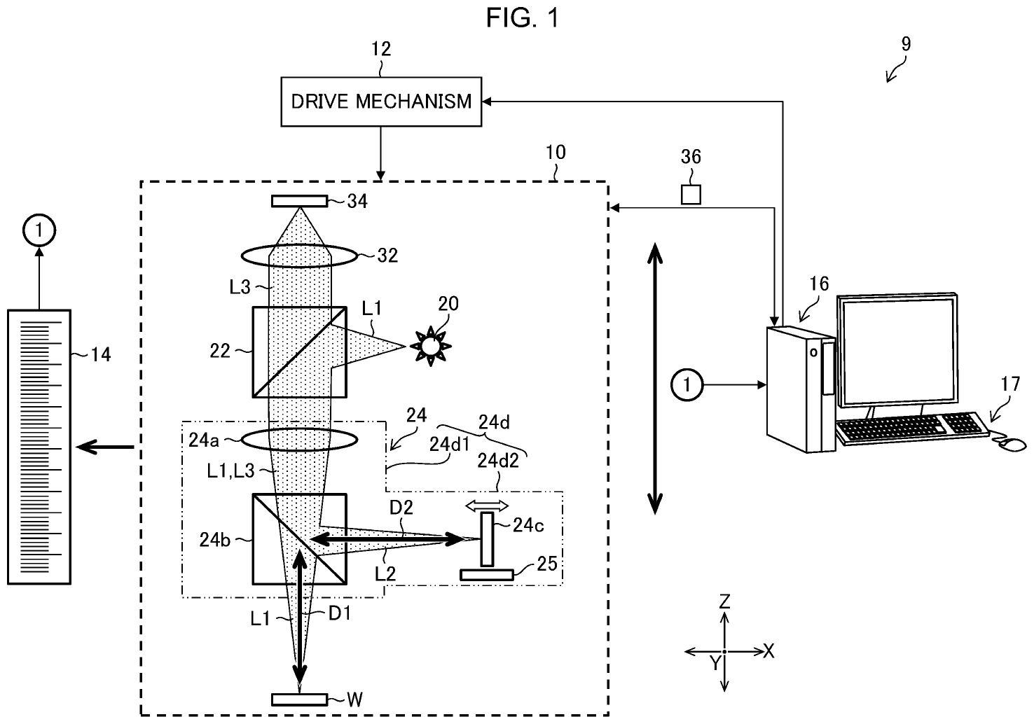

FIG. 1 is a schematic view of a three-dimensional shape measuring device 9 of a first embodiment. X and Y directions among X, Y and Z directions orthogonal to each other in the drawing are directions parallel to a horizontal direction, and the Z direction is a direction parallel to a vertical direction.

As illustrated in FIG. 1, the three-dimensional shape measuring device 9 measures a three-dimensional shape of a surface to be measured W using a FV scheme (focal point method). The three-dimensional shape measuring device 9 roughly includes a microscope 10, a drive mechanism 12, a scale 14, and a control device 16.

The microscope 10 includes a light source unit 20, a beam splitter 22, an interference objective lens 24, an imaging lens 32, and a camera 34. The interference objective lens 24, the beam splitter 22, the imaging lens 32, and the camera 34 are arranged in this order along the Z direction upward from the surface to be measured W. Further, the light source unit 20 is arranged at a position facing the beam splitter 22 in the X direction (or can be the Y direction).

The light source unit 20 emits white light (low-coherence light with low coherence) of a parallel light flux toward the beam splitter 22 as measurement light L1 under control of the control device 16. While not illustrated, the light source unit 20 includes a light source capable of emitting the measurement light L1, such as a light-emitting diode, a semiconductor laser, a halogen lamp and a high-brightness discharge lamp, and a contact lens that converts the measurement light L1 emitted from the light source into a parallel light flux.

As the beam splitter 22, for example, a half mirror is used. The beam splitter 22 reflects part of the measurement light L1 incident from the light source unit 20 toward the interference objective lens 24 on a lower side in the Z direction. Further, the beam splitter 22 allows part of multiplexed light L3 which is incident from the interference objective lens 24 and which will be described later to pass to the upper side in the Z direction and emits the multiplexed light L3 toward the imaging lens 32.

The interference objective lens 24 is detachably held to a publicly known objective lens holder (such as a revolver) of the microscope 10, in place of an objective lens for bright visual field observation (hereinafter shortened to an observational lens) used in general measurement by the FV scheme. The interference objective lens 24, which is a Michelson-type lens, includes an objective lens 24a, a beam splitter 24b, a reference surface 24c, and a holder 24d. The beam splitter 24b and the objective lens 24a are arranged in this order along the Z direction upward from the surface to be measured W, and the reference surface 24c is arranged at a position facing the beam splitter 24b in the X direction (or can be the Y direction).

The objective lens 24a has a focusing function and causes the measurement light L1 incident from the beam splitter 22 to focus on the surface to be measured W through the beam splitter 24b.

As the beam splitter 24b which corresponds to an interfering unit of the presently disclosed subject matter, for example, a half mirror is used. The beam splitter 24b splits part of the measurement light L1 incident from the objective lens 24a as reference light L2, allows the remaining measurement light L1 to pass and emits the remaining measurement light L1 to the surface to be measured W, and emits the reference light L2 to the reference surface 24c. A reference numeral D1 in the drawing indicates a measurement light path length that is an optical path length of the measurement light L1 between the beam splitter 24b and the surface to be measured W. The measurement light L1 that has passed through the beam splitter 24b is radiated on the surface to be measured W, then reflected by the surface to be measured W and returns to the beam splitter 24b.

As the reference surface 24c, for example, a reflecting mirror is used, and the reference surface 24c reflects the reference light L2 incident from the beam splitter 24b toward the beam splitter 24b. A position of the reference surface 24c in the X direction can be manually adjusted using a reference surface position adjustment mechanism 25.

The reference surface position adjustment mechanism 25, which is, for example, a screw-type fine adjustment mechanism, adjusts the position of the reference surface 24c in the X direction by being operated by an operator. This enables adjustment of a reference light path length D2 that is an optical path length of the reference light L2 between the beam splitter 24b and the reference surface 24c. Here, the position of the reference surface 24c in the X direction is adjusted by the reference surface position adjustment mechanism 25 so that the reference light path length D2 is equal (including roughly equal) to the measurement light path length D1 while the objective lens 24a focuses on the surface to be measured W. The method of adjusting the X-direction position of the reference surface 24c is not particularly limited, and an automatic adjustment mechanism using a publicly known actuator, a temperature adjustment mechanism (heater and temperature sensor) that reversibly thermally deforms the holder 24d (reference surface containing portion 24d2) as will be described later, or the like may be used.

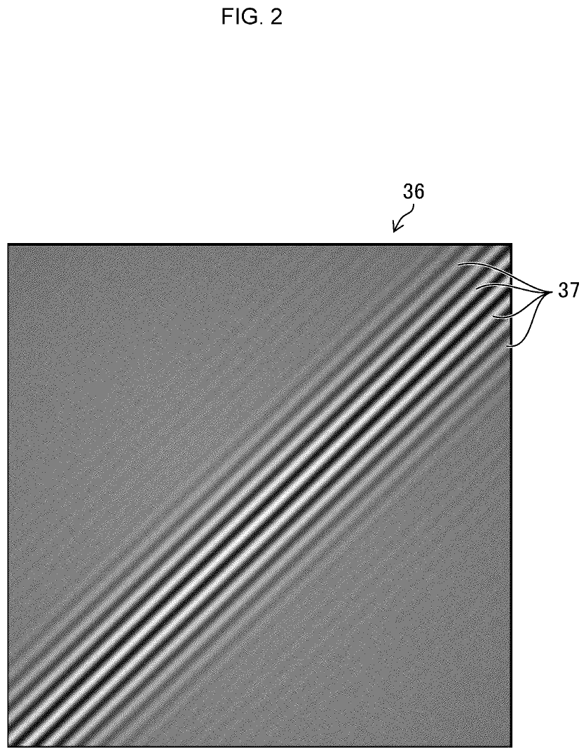

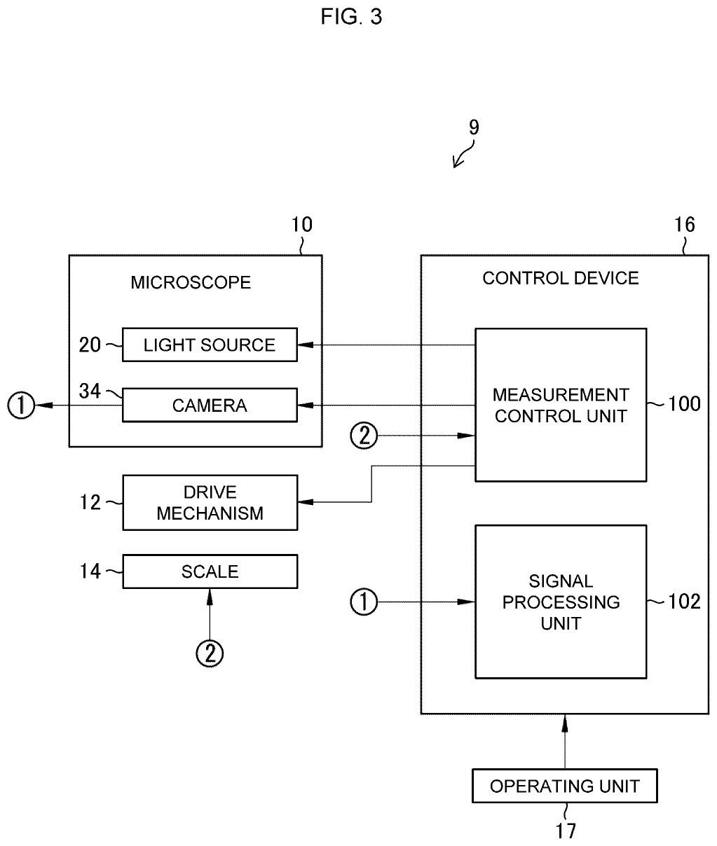

The beam splitter 24b generates the multiplexed light L3 of the measurement light L1 returning from the surface to be measured W and the reference light L2 returning from the reference surface 24c and emits the multiplexed light L3 toward the objective lens 24a on the upper side in the Z direction. The multiplexed light L3 passes through the objective lens 24a and the beam splitter 22 and is incident on the imaging lens 32. The multiplexed light L3, which is interference light of the measurement light L1 and the reference light L2, includes interference fringes 37 (see FIG. 2). When the objective lens 24a focuses on the surface to be measured W, the measurement light path length D1 is equal to the reference light path length D2 as described before, and therefore the intensity of the interference fringes 37 included in the multiplexed light L3 becomes stronger.

The holder 24d is formed of a metal material like, for example, brass. The holder 24d includes a lens barrel 24d1 and a reference surface containing portion 24d2. The lens barrel 24d1 is formed in a cylindrical shape extending in the Z direction and contains (holds) the objective lens 24a and the beam splitter 24b. The reference surface containing portion 24d2 is formed in a cylindrical shape extending in the X direction from a position at which the lens barrel 24d1 holds the beam splitter 24b and contains the reference surface 24c. As described above, the position of the reference surface 24c in the X direction can be manually adjusted using the reference surface position adjustment mechanism 25.

The imaging lens 32 forms an image of the multiplexed light L3 incident from the beam splitter 22 on an imaging surface (not illustrated) of the camera 34. Specifically, the imaging lens 32 forms an image of a point on a focal plane of the objective lens 24a on the imaging surface of the camera 34 as an image point.

The camera 34, which corresponds to an image capturing unit of the presently disclosed subject matter, includes a charge coupled device (CCD)-type or a complementary metal oxide semiconductor (CMOS)-type imaging element not illustrated. The camera 34 captures an image of the multiplexed light L3 formed on the imaging surface of the imaging element by the imaging lens 32 and performs signal processing on an imaging signal of the multiplexed light L3 obtained by the imaging and outputs the captured image 36.

FIG. 2 indicates an example of the captured image 36 of the surface to be measured W captured by the camera 34. Here, description is given by taking an optical flat surface (mirror surface) as an example of the surface to be measured W. As indicated in FIG. 2, when the objective lens 24a is focused on the surface to be measured W, the multiplexed light L3 includes the interference fringes 37 as described above, and therefore the captured image 36 also includes the interference fringes 37. As a result, the contrast of the surface to be measured W in the captured image 36 can be improved even when the surface to be measured W is a mirror surface (in this case, an optical flat surface).

Returning to FIG. 1, the drive mechanism 12 corresponds to a scanning unit of the presently disclosed subject matter. The drive mechanism 12 is constituted with various kinds of actuators such as a publicly known linear motor or a motor drive mechanism and holds the microscope 10 so as to be movable in the Z direction that is a scanning direction. The drive mechanism 12 causes the microscope 10 to scan along the Z direction, that is, the direction parallel to an optical axis of the objective lens 24a, under control of the control device 16. This enables change of the measurement light path length D1 upon measurement of the three-dimensional shape of the surface to be measured W.

The drive mechanism 12 only requires to be able to cause the microscope 10 to scan in the Z direction relatively with respect to the surface to be measured W and, for example, may cause the surface to be measured W (support portion that supports the surface to be measured W) to scan in the Z direction.

As the scale 14, which is a position detection sensor that detects a position of the microscope 10 in the Z direction, for example, a linear scale is used. The scale 14 repeatedly detects the position of the microscope 10 in the Z direction and repeatedly outputs the position detection result to the control device 16.

The control device 16 comprehensively controls operation of measuring the three-dimensional shape of the surface to be measured W by the microscope 10, calculation of the three-dimensional shape of the surface to be measured W, and the like, in accordance with input operation to an operating unit 17. The control device 16 includes an arithmetic circuit constituted with various kinds of processors, memories, and the like. The various kinds of processors include a central processing unit (CPU), a graphics processing unit (GPU), an application specific integrated circuit (ASIC), a programmable logic device (for example, a simple programmable logic device (SPLD), a complex programmable logic device (CPLD), and field programmable gate arrays (FPGA)), and the like. Various kinds of functions of the control device 16 may be implemented by one processor or may be implemented by a plurality of processors of the same type or different types.

FIG. 3 is a functional block diagram of the control device 16 of the first embodiment. As illustrated in FIG. 3, respective units (the light source unit 20 and the camera 34) of the microscope 10, the drive mechanism 12, the scale 14, and the operating unit 17 are connected to the control device 16.

The control device 16 functions as a measurement control unit 100 and a signal processing unit 102 by executing a control program (not illustrated) read out of a storage unit (not illustrated).

The measurement control unit 100 controls the drive mechanism 12, the light source unit 20 and the camera 34 to measure the three-dimensional shape of the surface to be measured W using the FV scheme. Specifically, the measurement control unit 100 controls the drive mechanism 12 to cause the microscope 10 to scan in the Z direction after emission of the measurement light L1 from the light source unit 20 is started. Further, the measurement control unit 100 causes the camera 34 to repeatedly capture the image of the multiplexed light L3 and output the captured image 36 to the control device 16 every time the microscope 10 moves in the Z direction by a fixed pitch based on the detection result of the position of the microscope 10 in the Z direction by the scale 14 while the drive mechanism 12 causes the microscope 10 to scan in the Z direction.

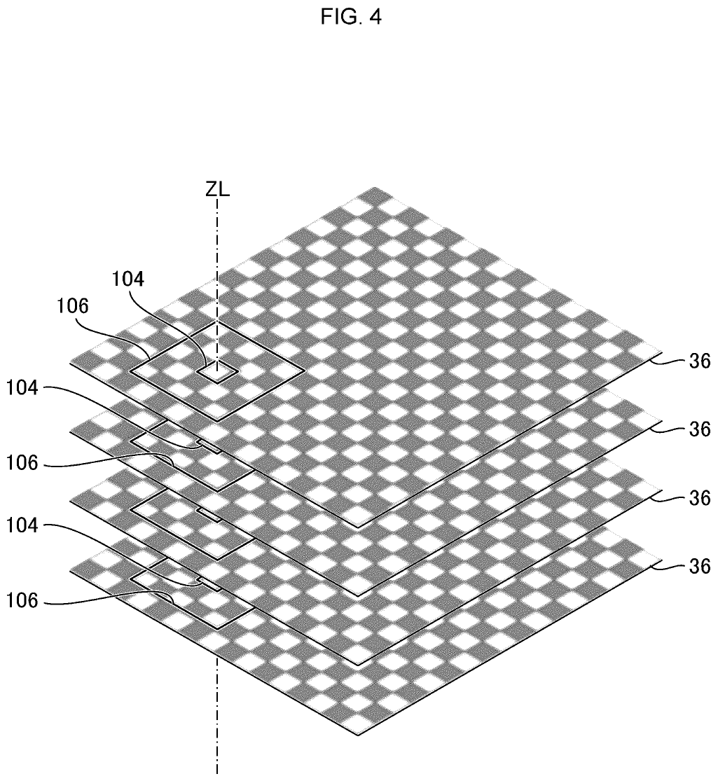

FIG. 4 is an explanatory diagram for describing calculation of the three-dimensional shape of the surface to be measured W by the signal processing unit 102. In FIG. 4, each pixel is expressed in a checkered pattern (checkerboard pattern) to make it easier to distinguish each pixel in the respective captured images 36.

The signal processing unit 102 corresponds to a first signal processing unit of the presently disclosed subject matter. The signal processing unit 102 acquires the captured image 36 output from the camera 34 every time the camera 34 captures the image of the multiplexed light L3. Next, the signal processing unit 102 calculates the sharpness (contrast, image sharpness) for each pixel of the respective captured images 36 acquired from the camera 34. For example, the signal processing unit 102 sets a pixel for calculating the sharpness as a target pixel 104, and calculates the sharpness by a publicly known method based on a luminance value of the target pixel 104 and a luminance value of each pixel within a sharpness calculation range 106 with the target pixel 104 as a reference. The signal processing unit 102 calculates the sharpness of each pixel in the respective captured images 36 by repeatedly executing processing to calculate the sharpness for all the pixels in the respective captured images 36.

After calculating the sharpness, the signal processing unit 102 compares the sharpness of each pixel on the same coordinate (each pixel of the imaging element of the camera 34) of the respective captured images 36 as indicated by a straight line ZL in the drawing, and determines the position in the Z direction at which the sharpness becomes maximum for each pixel on the same coordinate. The signal processing unit 102 then determines the focal position of the camera 34 for the surface to be measured W for each pixel on the same coordinate to calculate the three-dimensional shape (height distribution) of the surface to be measured W. Calculation of the three-dimensional shape of the surface to be measured W using the FV scheme is a publicly known technique (see PTL 1), and thus, detailed description is omitted here.

### Operation of First Embodiment

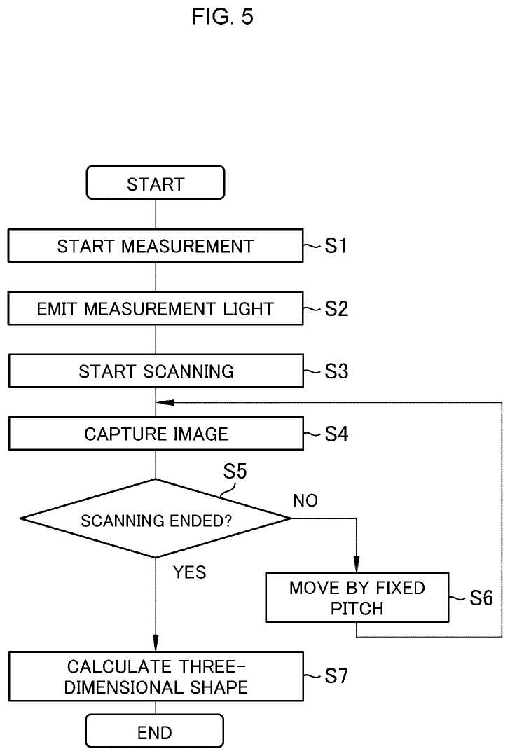

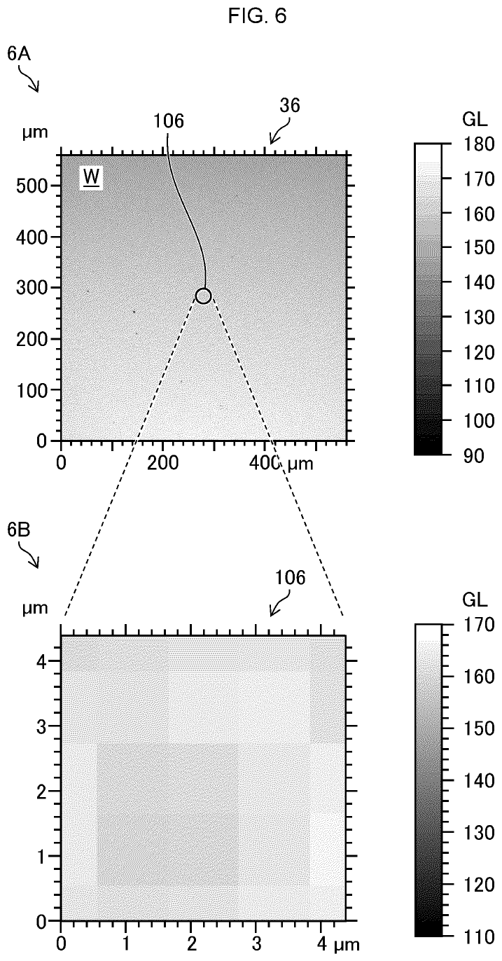

FIG. 5 is a flowchart indicating flow of processing of measuring the three-dimensional shape of the surface to be measured W by the three-dimensional shape measuring device 9 of the first embodiment according to the three-dimensional shape measuring method of the presently disclosed subject matter. The interference objective lens 24 is mounted on the microscope 10 in advance. The position of the reference surface 24c in the X direction is adjusted in advance so that the reference light path length D2 becomes equal to the measurement light path length D1 in a state where the objective lens 24a is focused on the surface to be measured W.

As indicated in FIG. 5, the operator sets the surface to be measured W that is a measurement object at the microscope 10 and operates the operating unit 17 to perform operation of starting measurement of the three-dimensional shape of the surface to be measured W (step S1). When the measurement start operation is performed, the measurement control unit 100 of the control device 16 starts emitting the measurement light L1 from the light source unit 20 (corresponding to an emitting step of the presently disclosed subject matter). As a result, the multiplexed light L3 that is made of the measurement light L1 reflected on the surface to be measured W and the reference light L2 reflected on the reference surface 24c and that includes the interference fringes 37 is incident on the camera 34 (corresponding to an interfering step of the presently disclosed subject matter). The measurement control unit 100 then controls the drive mechanism 12 to cause the microscope 10 to start scanning in the Z direction (step S3, corresponding to a scanning step of the presently disclosed subject matter).

Further, the measurement control unit 100 causes the camera 34 to repeatedly capture the image of the multiplexed light L3 every time the microscope 10 moves in the Z direction by a fixed pitch based on the detection result of the position of the microscope 10 in the Z direction by the scale 14 (step S4, NO in step S5, and step S6, corresponding to an image capturing step of the presently disclosed subject matter). Accordingly, during scanning by the microscope 10, the captured image 36 is repeatedly input from the camera 34 to the signal processing unit 102, and the signal processing unit 102 repeatedly acquires the captured image 36.

A reference numeral 6A of FIG. 6 is a front view of the captured image 36 obtained in a comparative example using the observational lens in the measurement by the FV scheme (hereinafter shortened to the comparative example), and a reference numeral 6B of FIG. 6 is an enlarged view of a given sharpness calculation range 106 in the captured image 36. A reference numeral 7A of FIG. 7 is a front view of the captured image 36 obtained in the present example using the interference objective lens 24 in the measurement by the FV scheme (hereinafter shortened to the present example), and a reference numeral 7B of FIG. 7 is an enlarged view of the given sharpness calculation range 106 in the captured image 36. The surface to be measured W indicated in FIGS. 6 and 7 is an optical flat surface, that is, a mirror surface.

As indicated by the reference numerals 6A and 6B in FIG. 6, in the comparative example, the camera 34 captures the image of the measurement light L1 returned from the surface to be measured W through the observational lens, that is, the image of return light that does not include the interference fringes 37, and therefore the interference fringes 37 are not generated on the surface to be measured W in the captured image 36. Thus, in the comparative example, the contrast of the surface to be measured W in the captured image 36 decreases, and the contrast within the sharpness calculation range 106 also decreases.

On the contrary, in the present example as indicated in the reference numerals 7A and 7B of FIG. 7, the camera 34 captures the image of the surface to be measured W through the interference objective lens 24, that is, the image of the multiplexed light L3 including the interference fringes 37, which results in generation of the interference fringes 37 on the surface to be measured W in the captured image 36. Therefore, in the present example, the contrast of the surface to be measured W in the captured image 36 is improved, and the contrast within the sharpness calculation range 106 is also improved.

Returning to FIG. 5, when scanning of the microscope 10 ends (YES in step S5), as indicated in FIG. 4, the signal processing unit 102 repeatedly sets the target pixel 104 and the sharpness calculation range 106 and repeatedly calculates the sharpness for all the pixels of the respective captured images 36. Next, the signal processing unit 102 compares the sharpness of each pixel on the same coordinate of the respective captured images 36 and determines the position in the Z direction at which the sharpness becomes maximum for each pixel on the same coordinate, so that the focal position of the camera 34 for the surface to be measured W is determined for each pixel on the same coordinate. By this means, the signal processing unit 102 calculates the three-dimensional shape (height distribution) of the surface to be measured W (step S7, corresponding to a signal processing step of the presently disclosed subject matter).

Hereinafter, the measurement result of the three-dimensional shape of the surface to be measured W in the present example is compared with the measurement result of the three-dimensional shape of the surface to be measured W in the comparative example.

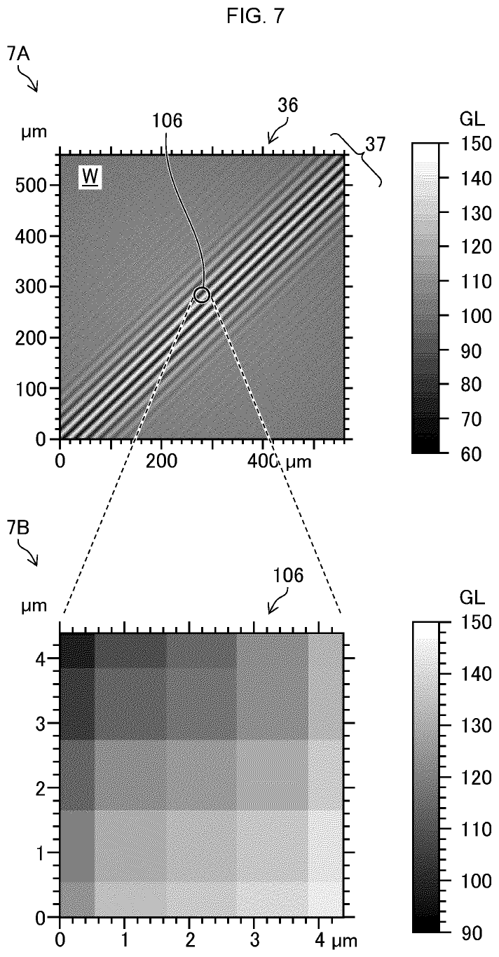

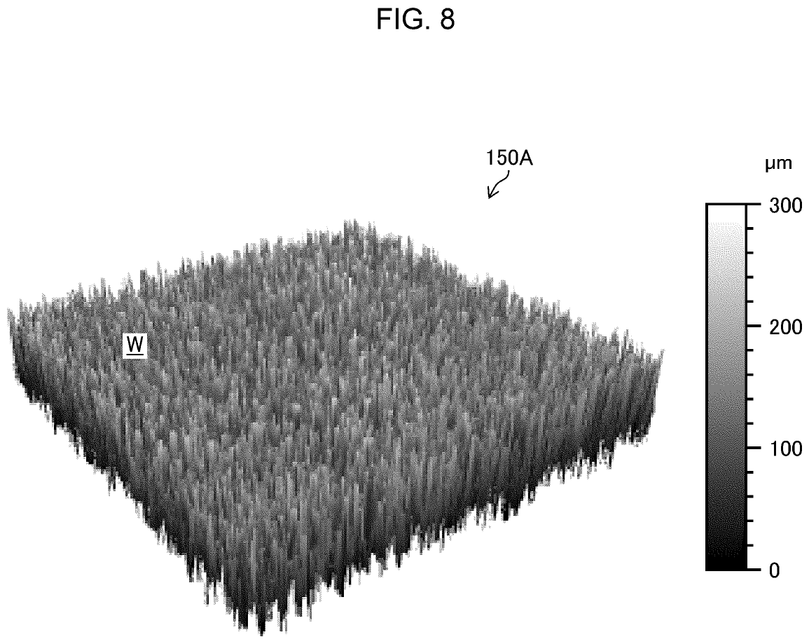

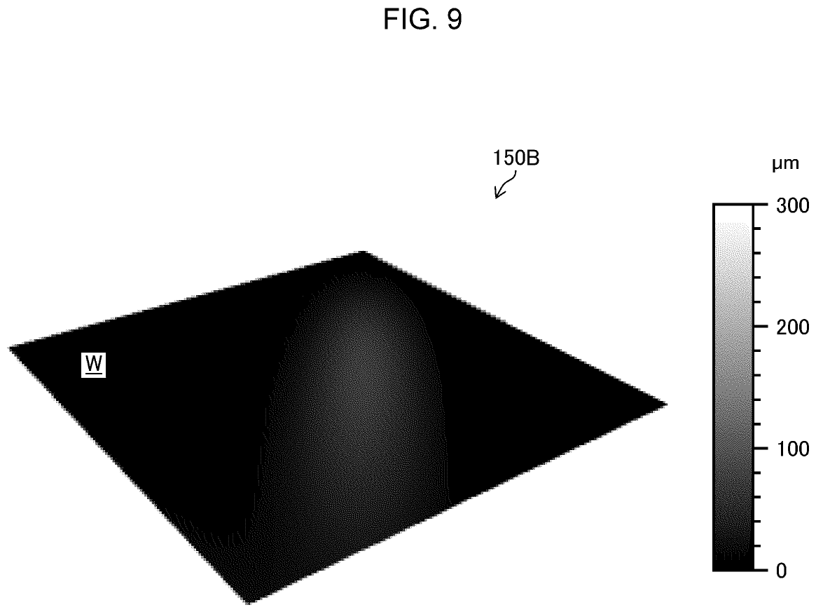

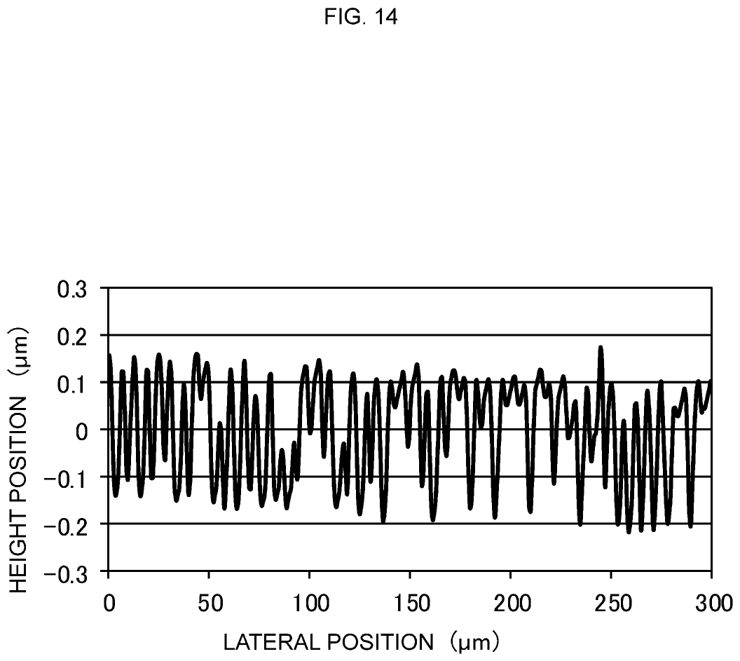

FIG. 8 is an explanatory diagram indicating an example of an optical flat surface shape 150A, which is the three-dimensional shape of an optical flat surface measured in the comparative example. FIG. 9 is an explanatory diagram indicating an example of an optical flat surface shape 150B, which is the three-dimensional shape of an optical flat surface measured in the present example. FIG. 10 is a graph indicating comparison between a cross-sectional curve of the optical flat surface based on the optical flat surface shape 150A in the comparative example and a cross-sectional curve of the optical flat surface based on the optical flat surface shape 150B in the present example. “LATERAL POSITION” in FIG. 10 indicates the position on a given straight line along the optical flat surface, and “HEIGHT POSITION” in FIG. 10 indicates a height position of the optical flat surface in the Z direction on the given straight line (this also applies to FIG. 14 described later).

As indicated in FIGS. 8 to 10, in the comparative example, when the surface to be measured W is an optical flat surface (mirror surface), the optical flat surface shape 150A becomes noisy and the three-dimensional shape of the surface to be measured W becomes difficult to measure. On the contrary, in the present example, even when the surface to be measured W is an optical flat surface (mirror surface), generation of noise on the optical flat surface shape 150B is suppressed, so that the three-dimensional shape measurement of the surface to be measured W becomes possible.

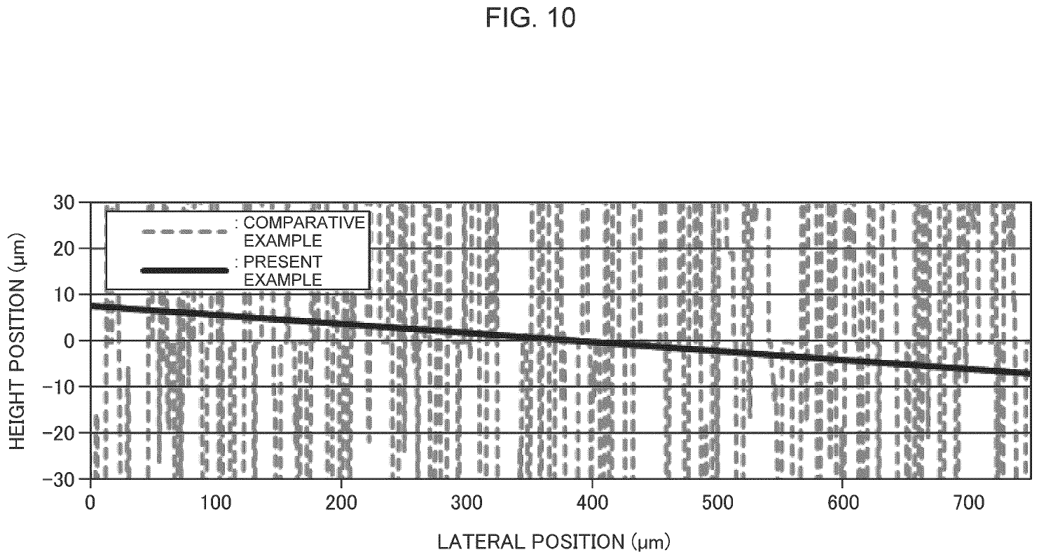

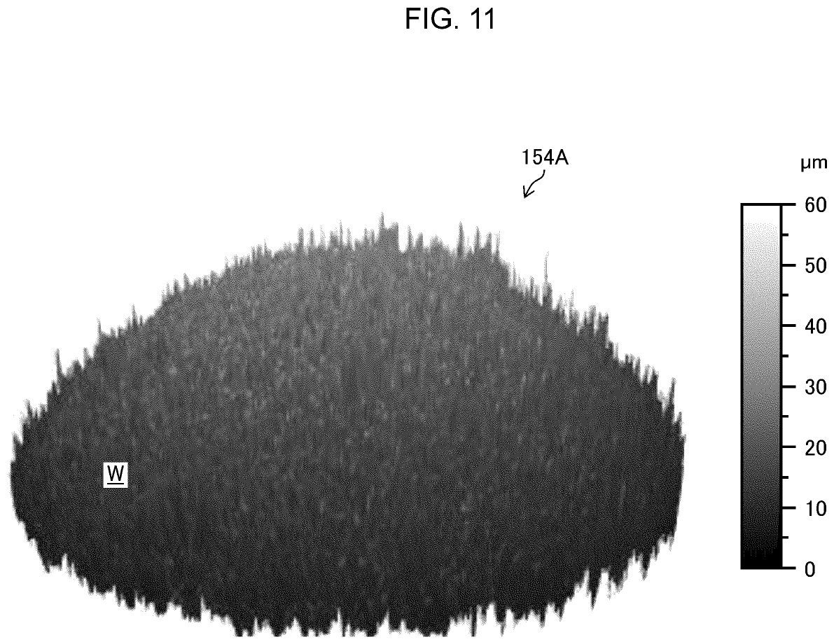

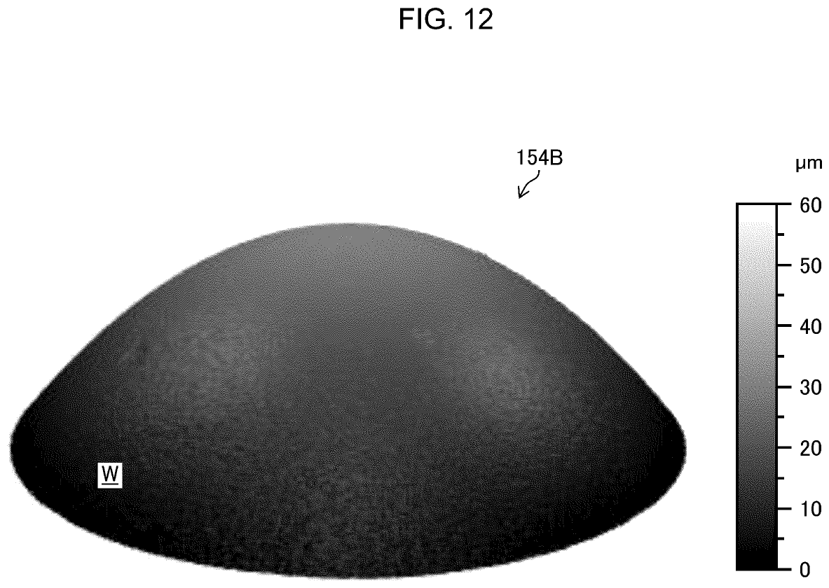

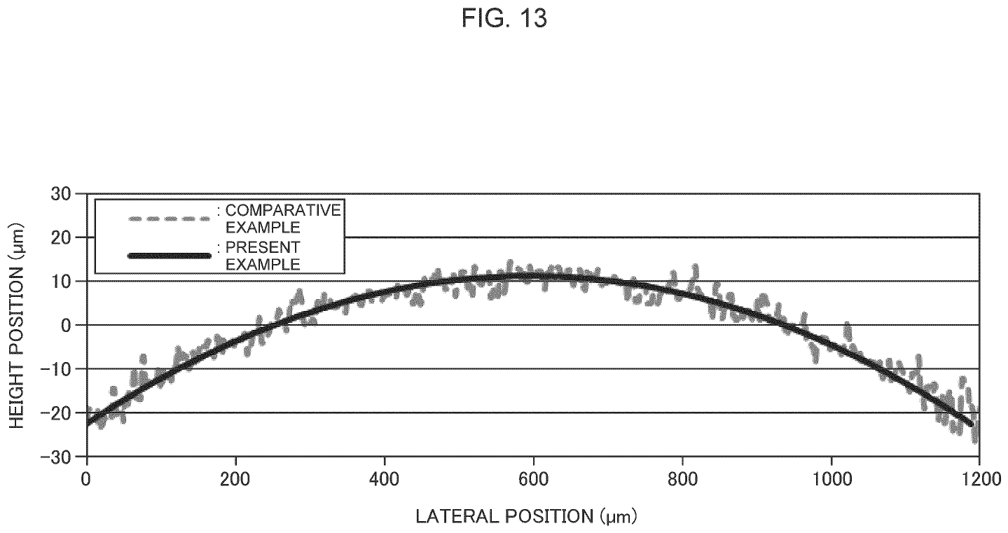

FIG. 11 is an explanatory diagram indicating an example of a ball bearing surface shape 154A, which is the three-dimensional shape of a ball bearing surface measured in the comparative example. FIG. 12 is an explanatory diagram indicating an example of a ball bearing surface shape 154B, which is the three-dimensional shape of a ball bearing surface measured in the present example. FIG. 13 is a graph indicating comparison between a cross-sectional curve of the ball bearing surface based on the ball bearing surface shape 154A in the comparative example and a cross-sectional curve of the ball bearing surface based on the ball bearing surface shape 154B in the present example. “LATERAL POSITION” in FIG. 13 indicates the position on a given curve along the ball bearing surface, and “HEIGHT POSITION” indicates a height position of the ball bearing surface on the given curve.

As indicated in FIGS. 11 to 13, when the surface to be measured W is a ball bearing surface, the resolution of the ball bearing surface shape 154A in the height direction is about 10 μm in the comparative example, whereas the resolution of the ball bearing surface shape 154B in the height direction is about 1 μm in the present example. This indicates that the resolution of the three-dimensional shape of the surface to be measured W in the present example can be made higher than that in the comparative example.

Thus, in the present example, the contrast of the surface to be measured W (sharpness calculation range 106) in the captured image 36 is improved by generating the interference fringes 37 on the surface to be measured W in the captured image 36 by the interference objective lens 24, so that measurement sensitivity and resolution of the three-dimensional shape of the surface to be measured W are improved. Therefore, the measurement accuracy of the three-dimensional shape of the surface to be measured W is improved in the present example. Further, as compared with the texture pattern described in PTL 1, the interference fringes 37 show a larger change in luminance when the microscope 10 is made to scan in the Z direction, and therefore the measurement sensitivity and resolution of the three-dimensional shape of the surface to be measured W are further improved, that is, the measurement accuracy of the three-dimensional shape is further improved.

Further, since the three-dimensional shape of the surface to be measured W is measured by the FV scheme in the present example, it is possible to improve the measurement accuracy of the three-dimensional shape of the surface to be measured W, while performing high-speed measurement by the FV scheme. For example, in a case of performing the three-dimensional shape measurement of the ball bearing surface indicated in FIGS. 11 and 12, the measurement time by the FV scheme is 5 seconds, which is about ⅓ of the measurement time of the WLI method that is 16 seconds.

Thus, in the first embodiment, the measurement accuracy of the three-dimensional shape of the surface to be measured W is improved simply by providing the interference objective lens 24 in the microscope 10, which makes it unnecessary to provide the projection system of the texture pattern described in PTL 1 in the microscope 10 or to provide the interference light generation means and the light shielding plate described in PTL 2 in the microscope 10. As a result, the presently disclosed subject matter is also easily applicable to existing three-dimensional shape measuring devices (microscopes) employing the FV scheme, which makes it possible to easily improve the measurement accuracy of the three-dimensional shape of the surface to be measured W. Further, in the first embodiment, an examiner does not need to insert or remove the light shielding plate as described in PTL 2, and this makes it possible to reduce the time and effort of the examiner. As a result, the first embodiment can reduce the time and effort of the examiner and easily improve the measurement accuracy of the three-dimensional shape of the surface to be measured W.

In the shape measuring device described in PTL 2, the depth of field of the objective lens is set to be equal to or less than the measurement accuracy of the three-dimensional shape of the surface to be measured W, though in the first embodiment, it is not necessary to set the depth of field of the objective lens 24a to be equal to or less than the measurement accuracy of the three-dimensional shape of the surface to be measured W.

Specifically, when a numerical aperture (NA) of the objective lens 24a is, for example, 0.3, and a wavelength of the measurement light L1 is, for example, 0.53 μm, a depth of field of the objective lens 24a is expressed by “depth of field=[wavelength/(2×NA²)]=2.94 μm”. On the other hand, as indicated in FIG. 14, in the three-dimensional shape measurement result of the optical flat surface (surface to be measured W) in the first embodiment, a peak-to-peak (PP) is 0.4 μm or less. Accordingly, in the first embodiment, it is not necessary to set the depth of field of the objective lens 24a to be equal to or less than the measurement accuracy of the three-dimensional shape of the surface to be measured W. Here, FIG. 14 is a graph indicating a cross-sectional curve of the optical flat surface measured in the first embodiment.

### Second Embodiment

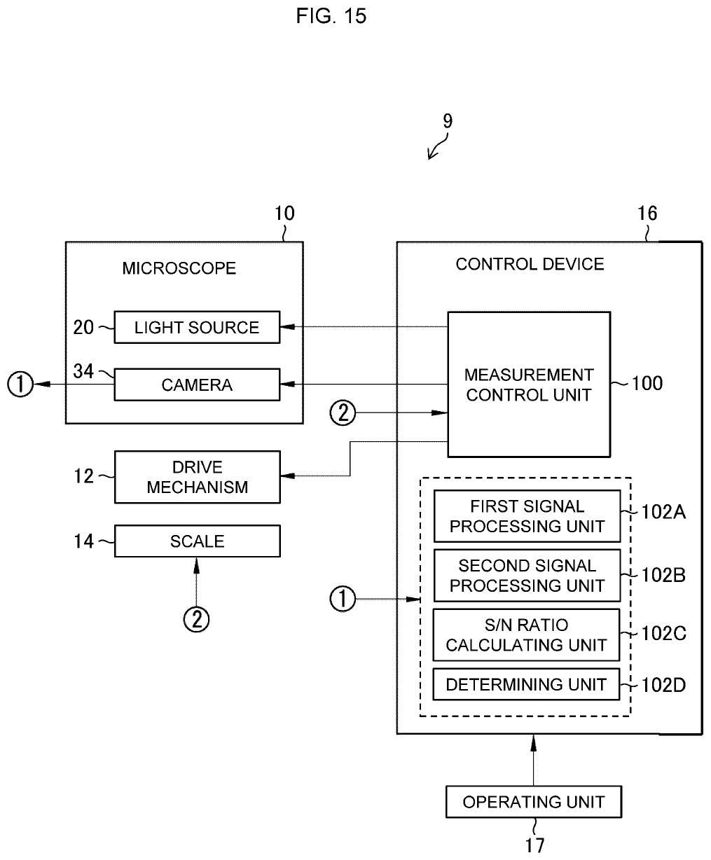

FIG. 15 is a functional block diagram of the control device 16 for the three-dimensional shape measuring device 9 of a second embodiment. The three-dimensional shape measuring device 9 of the first embodiment only performs calculation of the three-dimensional shape of the surface to be measured W by the FV scheme based on the captured images 36 obtained during scanning of the microscope 10. In contrast, the three-dimensional shape measuring device 9 in the second embodiment performs calculation of the three-dimensional shape of the surface to be measured W by two types of schemes: the FV scheme; and the WLI scheme concurrently (or may be in sequence) based on the captured images 36 obtained during the scanning of the microscope 10, and compares calculation results of the three-dimensional shape by the two schemes to select the result having a better signal-noise ratio (S/N ratio).

The three-dimensional shape measuring device 9 of the second embodiment has basically the same configuration as the three-dimensional shape measuring device 9 of the first embodiment except that the control device 16 functions as a first signal processing unit 102A, a second signal processing unit 102B, an S/N ratio calculating unit 102C, and a determining unit 102D. Thus, functions or components that are the same as those in the first embodiment will be denoted by the same reference numerals, and description thereof will be omitted.

The first signal processing unit 102A, which is the same as the signal processing unit 102 in the first embodiment, calculates the three-dimensional shape of the surface to be measured W by the FV scheme based on the captured images 36 output from the camera 34 during the scanning of the microscope 10.

The second signal processing unit 102B calculates the three-dimensional shape of the surface to be measured W by the WLI scheme based on the captured images 36 output from the camera 34 during the scanning of the microscope 10. Specifically, the second signal processing unit 102B compares luminance values for each pixel on the same coordinate in the respective captured images 36. Next, the second signal processing unit 102B determines a position in the Z direction at which the luminance value becomes maximum for each pixel on the same coordinate of the respective captured images 36 to calculate height information of the surface to be measured W for each pixel on the same coordinate. By this means, the three-dimensional shape (height distribution) of the surface to be measured W is calculated. Calculation of the three-dimensional shape of the surface to be measured W using the WLI scheme is also a publicly known technique (see, for example, Japanese Patent Application Laid-Open No. 2017-106860), and thus, detailed description is omitted here.

The S/N ratio calculating unit 102C, which corresponds to a first evaluation value calculating unit of the presently disclosed subject matter, calculates an S/N ratio of the calculation result of the three-dimensional shape of the surface to be measured W by the first signal processing unit 102A and an S/N ratio of the calculation result of the three-dimensional shape of the surface to be measured W by the second signal processing unit 102B. The S/N ratio is an example of the evaluation value of the presently disclosed subject matter, and since a calculation method of the S/N ratio is a publicly known technology, the detailed explanation is omitted here (see, for example, Japanese Patent Application Laid-Open No. 2021-33525).

The determining unit 102D compares, based on the calculation results of the S/N ratio calculating unit 102C, the S/N ratio of the calculation result of the three-dimensional shape of the surface to be measured W by the first signal processing unit 102A and the S/N ratio of the calculation result of the three-dimensional shape of the surface to be measured W by the second signal processing unit 102B. The determining unit 102D then determines the result having a higher S/N ratio, out of the calculation result of the three-dimensional shape by the first signal processing unit 102A and the calculation result of the three-dimensional shape by the second signal processing unit 102B, as the measurement result of the three-dimensional shape of the surface to be measured W.

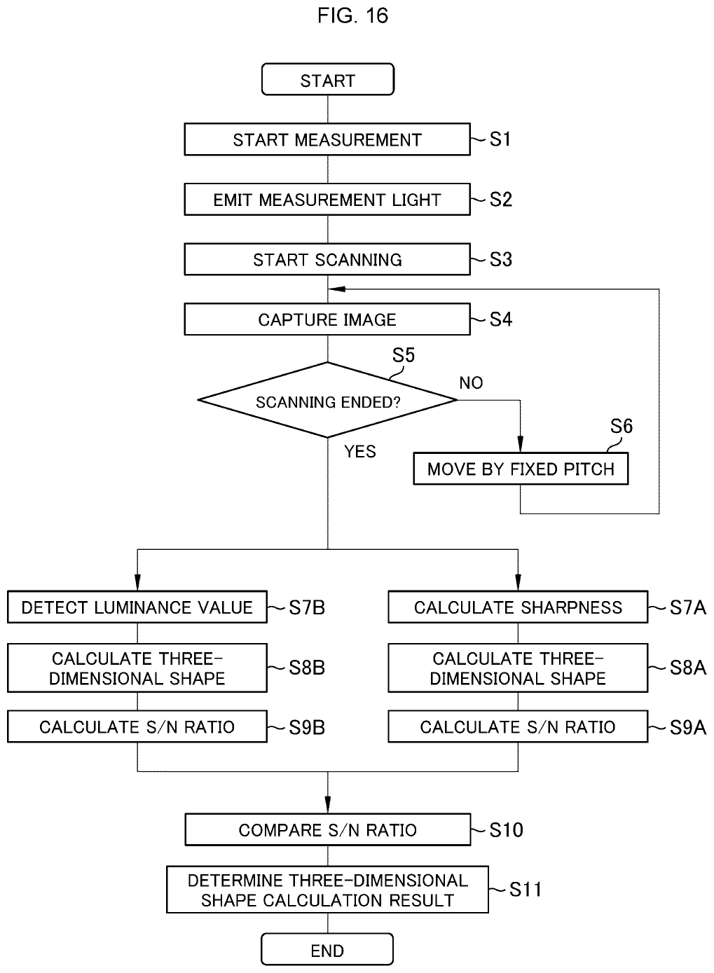

FIG. 16 is a flowchart indicating flow of processing of measuring the three-dimensional shape of the surface to be measured W by the three-dimensional shape measuring device 9 of the second embodiment. As indicated in FIG. 16, the processing from step S1 to step S6 is basically the same as the processing in the first embodiment indicated in FIG. 5, and thus, specific description is omitted here.

When scanning of the microscope 10 ends (YES in step S5), the first signal processing unit 102A calculates the sharpness for each pixel of the captured images 36 input from the camera 34 (step S7A). Next, the first signal processing unit 102A calculates the three-dimensional shape of the surface to be measured W as in the case of the signal processing unit 102 in the first embodiment, based on the result of comparing the sharpness for each pixel on the same coordinate of the respective captured images 36 (step S8A).

Further, the second signal processing unit 102B detects the luminance values for each pixel of the captured images 36 input from the camera 34 (step S7B). The second signal processing unit 102B then determines a position in the Z direction at which the luminance values for each pixel on the same coordinate of the respective captured images 36 become maximum, and calculates height information of the surface to be measured W for each pixel on the same coordinate so as to calculate the three-dimensional shape of the surface to be measured W (step S8B).

Then, the S/N ratio calculating unit 102C calculates an S/N ratio of the calculation result of the three-dimensional shape of the surface to be measured W by the first signal processing unit 102A and an S/N ratio of the calculation result of the three-dimensional shape of the surface to be measured W by the second signal processing unit 102B (step S9).

When calculation of the S/N ratios by the S/N ratio calculating unit 102C is completed, the determining unit 102D determines the result having a higher S/N ratio, out of the calculation result of the three-dimensional shape by the first signal processing unit 102A and the calculation result of the three-dimensional shape by the second signal processing unit 102B, as the measurement result of the three-dimensional shape of the surface to be measured W (step S10). By this means, when the surface to be measured W is a surface suitable for the FV scheme, such as a steep inclined surface, the determining unit 102D determines the calculation result of the three-dimensional shape by the first signal processing unit 102A as the measurement result of the three-dimensional shape of the surface to be measured W. Conversely, when the surface to be measured W is suitable for the WLI scheme, such as a mirror surface, or a surface that requires high resolution in the Z direction (height direction) (such as a ball bearing surface), the determining unit 102D determines the calculation result of the three-dimensional shape by the second signal processing unit 102B as the measurement result of the three-dimensional shape of the surface to be measured W.

Thus, in the second embodiment, when calculation of the three-dimensional shape of the surface to be measured W by the FV scheme and by the WLI scheme is concurrently performed based on the captured images 36 obtained during the scanning of the microscope 10 and the calculation results of three-dimensional shape by the two schemes are compared to select the result having a better S/N ratio, it becomes possible to execute measurement by the FV scheme and the WLI scheme in one measurement operation (scanning of the microscope 10). As a result, the three-dimensional shape of the surface to be measured W, which is not suitable for the measurement in the WLI scheme, such as a steep inclined surface, can be measured by the FV scheme, whereas the three-dimensional shape of the surface to be measured W, which is not suitable for the measurement in the FV scheme, such as a mirror surface, can be measured by the WLI scheme.

### Third Embodiment

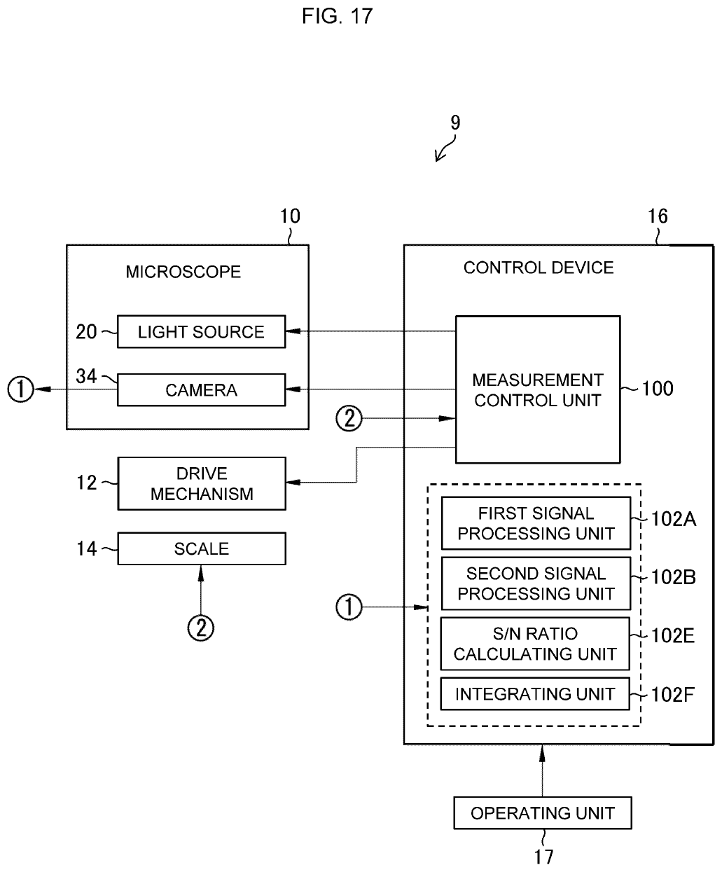

FIG. 17 is a functional block diagram of the control device 16 for the three-dimensional shape measuring device 9 of a third embodiment. The three-dimensional shape measuring device 9 of the second embodiment concurrently calculates the three-dimensional shape of the surface to be measured W by the FV scheme and the WLI scheme, and compares the results of three-dimensional shape calculation by the two schemes to select the result having a better S/N ratio. In contrast, the three-dimensional shape measuring device 9 of the third embodiment calculates an integrated three-dimensional shape of the surface to be measured W based on the results of the three-dimensional shape calculation by the two types of schemes.

As indicated in FIG. 17, the three-dimensional shape measuring device 9 of the third embodiment has basically the same configuration as the three-dimensional shape measuring device 9 of the second embodiment except that the control device 16 functions as “S/N ratio calculating unit 102E and integrating unit 102F” instead of “the S/N ratio calculating unit 102C and the determining unit 102D”. Thus, functions and components that are the same as those in the respective embodiments will be denoted by the same reference numerals, and description thereof will be omitted.

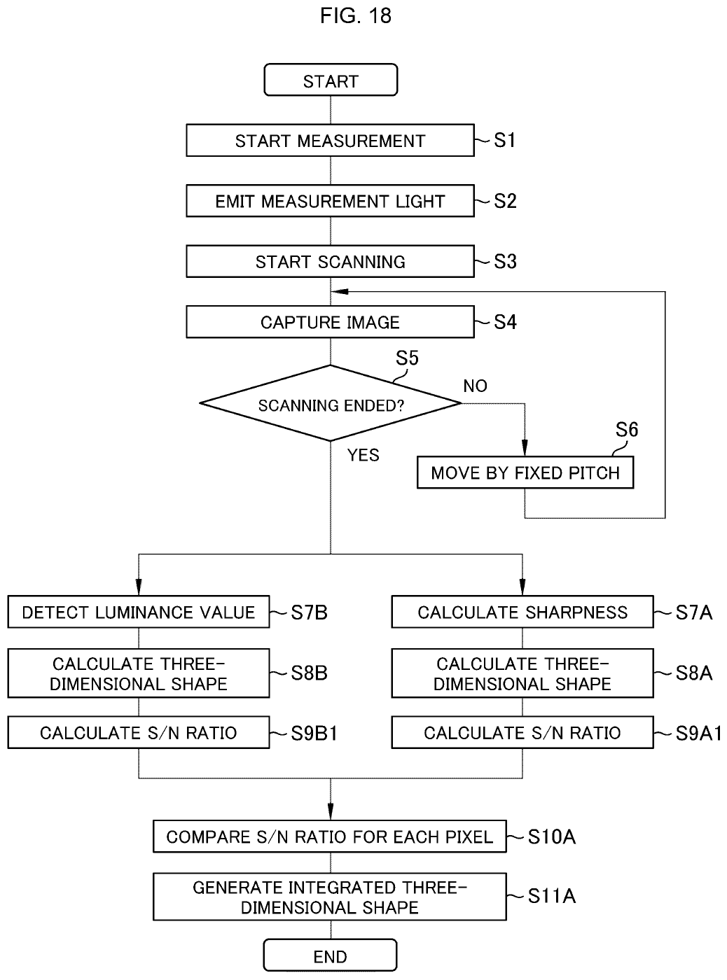

FIG. 18 is a flowchart indicating flow of processing of measuring the three-dimensional shape of the surface to be measured W by the three-dimensional shape measuring device 9 of the third embodiment. As indicated in FIG. 18, the processing from step S1 to steps S8A and S8B is basically the same as the processing in the second embodiment indicated in FIG. 16, and thus, the detailed description is omitted here.

The S/N ratio calculating unit 102E corresponds to a second evaluation value calculating unit of the presently disclosed subject matter. After processing of steps S8A and S8B, the S/N ratio calculating unit 102E calculates an S/N ratio of the calculation result of the three-dimensional shape of the first signal processing unit 102A (step S9A1) and also calculates an S/N ratio of the calculation result of the three-dimensional shape of the second signal processing unit 102B (step S9B1) for each pixel of the respective captured images 36 (for each pixel of the imaging element of the camera 34). Since a calculation method of the S/N ratio for each pixel is also a publicly known technology, the detailed explanation is omitted here (see, for example, Japanese Patent Application Laid-Open No. 2007-68597).

Based on the calculation results of the S/N ratio calculating unit 102E, the integrating unit 102F compares the S/N ratio of the calculation result of the three-dimensional shape in the first signal processing unit 102A and the S/N ratio of the calculation result of the three-dimensional shape in the second signal processing unit 102B for each pixel described above to select the result with a higher S/N ratio (step S10A). The integrating unit 102F then integrates the calculation results of the three-dimensional shape selected for each pixel to generate an integrated three-dimensional shape of the surface to be measured W (step S11A).

Thus, in the third embodiment, the integrated three-dimensional shape of the surface to be measured W is generated based on the result of selecting the result with a higher S/N ratio, out of the results of the three-dimensional shape calculation in the first signal processing unit 102A and the second signal processing unit 102B for each pixel, which makes it possible to obtain both the advantage of the measurement by the FV scheme and the advantage of the measurement by the WLI scheme. As a result, it is possible to perform high-accuracy measurement of the three-dimensional shape of the surface to be measured W, which is a mixture of a steep inclined surface that can be measured with high accuracy by the FV scheme and a mirror surface that can be measured with high accuracy by the WLI scheme.

### Others

While in the second embodiment and the third embodiment, the S/N ratio has been described as the evaluation value of the result of the three-dimensional shape calculation as an example, evaluation values other than the S/N ratio may be used as long as the evaluation values can be used as an index of the measurement accuracy of the three-dimensional shape of the surface to be measured W.

Although in each of the embodiments, the Michelson-type interference objective lens 24 is provided in the microscope 10, it is possible to provide various publicly known interference objective lens, such as Mirau-type and Linnik-type interference objective lenses.

While in each of the embodiments, the drive mechanism 12 causes the microscope 10 to scan in the Z direction, a scanning target is not particularly limited if at least the interference objective lens 24 can be caused to scan relatively with respect to the surface to be measured W in the Z direction.

### REFERENCE SIGNS LIST

9 Three-dimensional shape measuring device
10 Microscope
12 Drive mechanism
14 Scale
16 Control device
17 Operating unit
20 Light source unit
22 Beam splitter
24 Interference objective lens
24a Objective lens
24b Beam splitter
24c Reference surface
24d Holder
24d1 Lens barrel
24d2 Reference surface containing portion
25 Reference surface position adjustment mechanism
32 Imaging lens
34 Camera
36 Captured image
37 Interference fringe
100 Measurement control unit
102 Signal processing unit
102A First signal processing unit
102B Second signal processing unit
102C S/N-ratio calculating unit
102D Determining unit
102E S/N-ratio calculating unit
102F Integrating unit
104 Target pixel
106 Sharpness calculation range
150A, 150B Optical flat surface shape
154A, 154B Ball bearing surface shape
D1 Measurement light path length
D2 Reference light path length
L1 Measurement light
L2 Reference light
L3 Multiplexed light
W Surface to be measured

What is claimed is:

1. A three-dimensional shape measuring device configured to measure a three-dimensional shape of a surface to be measured by a focal point method, comprising:
a light source unit configured to emit measurement light;
an interference objective lens including an interfering unit configured to separate part of the measurement light emitted from the light source unit as reference light, emit the measurement light to the surface to be measured, emit the reference light to a reference surface, and generate multiplexed light of the measurement light returning from the surface to be measured and the reference light returning from the reference surface, and an objective lens configured to cause the measurement light to focus on the surface to be measured;
a scanning unit configured to cause the interference objective lens to scan in a scanning direction that is parallel to an optical axis of the objective lens relatively with respect to the surface to be measured;
an image capturing unit configured to repeatedly capture an image of the multiplexed light generated by the interfering unit and output a plurality of captured images including interference fringes during scanning by the scanning unit; and
a first signal processing unit configured to calculate sharpness of each pixel of the plurality of captured images output from the image capturing unit and calculate the three-dimensional shape of the surface to be measured, based on a result of comparing the sharpness of each pixel on the same coordinate of the plurality of captured images.

2. The three-dimensional shape measuring device according to claim 1, wherein when an optical path length of the measurement light between the interfering unit and the surface to be measured is set as a measurement light path length and an optical path length of the reference light between the interfering unit and the reference surface is set as a reference light path length, the measurement light path length is equal to the reference light path length.

3. The three-dimensional shape measuring device according to claim 1, comprising:
a second signal processing unit configured to calculate height information of the surface to be measured for each pixel to calculate the three-dimensional shape of the surface to be measured based on luminance values for each pixel on the same coordinate of the plurality of captured images output from the image capturing unit;
a first evaluation value calculating unit configured to calculate an evaluation value of a calculation result of the first signal processing unit and an evaluation value of a calculation result of the second signal processing unit; and
a determining unit configured to determine a calculation result of the three-dimensional shape of the surface to be measured out of the calculation result of the first signal processing unit or the calculation result of the second signal processing unit, whichever has a higher evaluation value based on results of calculation of the first evaluation value calculating unit.

4. The three-dimensional shape measuring device according to claim 1, comprising:
a second signal processing unit configured to calculate height information of the surface to be measured for each pixel to calculate the three-dimensional shape of the surface to be measured based on luminance values for each pixel on the same coordinate of the plurality of captured images output from the image capturing unit;
a second evaluation value calculating unit configured to calculate for each pixel an evaluation value of a calculation result of the first signal processing unit and an evaluation value of a calculation result of the second signal processing unit; and
an integrating unit configured to generate an integrated three-dimensional shape of the surface to be measured by selecting, for each pixel the calculation result of the first signal processing unit or the calculation result of the second signal processing unit, whichever has a higher evaluation value based on results of calculation of the second evaluation value calculating unit.

5. The three-dimensional shape measuring device according to claim 3, wherein the evaluation value is a signal to noise ratio.

6. The three-dimensional shape measuring device according to claim 1, wherein the scanning unit causes a microscope including the interference objective lens and the image capturing unit to scan relatively with respect to the surface to be measured.

7. A three-dimensional shape measuring method that measures a three-dimensional shape of a surface to be measured by a focal point method, comprising:
an emitting step of emitting measurement light;
an interfering step of separating part of the measurement light emitted in the emitting step as reference light, emitting the measurement light to the surface to be measured, emitting the reference light to a reference surface, and generating multiplexed light of the measurement light returning from the surface to be measured and the reference light returning from the reference surface;
a scanning step of causing an interference objective lens, including an interfering unit configured to perform the interfering step and an objective lens configured to cause the measurement light to focus on the surface to be measured, to scan in a scanning direction that is parallel to an optical axis of the objective lens relatively with respect to the surface to be measured;
an image capturing step of repeatedly capturing an image of the multiplexed light generated in the interfering step and outputting a plurality of captured images including interference fringes during the scanning step; and
a signal processing step of calculating sharpness of each pixel of the plurality of captured images output in the image capturing step and calculating the three-dimensional shape of the surface to be measured, based on a result of comparing the sharpness of each pixel on the same coordinate of the plurality of captured images.
